(19) United States
(12) Patent Application Publication
(10) Pub. No.: US 2026/0368539 A1
(43) Pub. Date: Nov. 19, 2026

(54) SYSTEMS AND METHODS FOR BUILDING AI AGENTS USING REASONING LANGUAGE MODELS

(71) Applicant: Salesforce, Inc., San Francisco, CA (US)

(72) Inventors: Yuhui Xu, Singapore (SG); Hanze Dong, Singapore (SG); Lei Wang, Singapore (SG); Doyen Sahoo, Singapore (SG); Junnan Li, Singapore (SG); Caiming Xiong, Menlo Park, CA (US)

(21) Appl. No.: 19/320,908

(22) Filed: Sep. 5, 2025

Related U.S. Application Data
(60) Provisional application No. 63/804,902, filed on May 13, 2025.

(51) Int. Cl. G06N 3/092; G06N 3/09

(52) U.S. Cl. CPC G06N 3/092; G06N 3/09

(57) ABSTRACT

A method for building an artificial intelligence (AI) agent is provided. The method includes obtaining a training dataset including a training query and a groundtruth answer; generating a training output including a reasoning portion subject to a first generative budget and a solution portion that results from the reasoning portion subject to a second generative budget; assigning a reward based on a comparison between the solution portion and the groundtruth answer; and updating parameters of a first neural network based language model based on a gradient of an expected return based on the reward. The method also includes: iteratively refining the training output while maintaining the training output under a total generative budget; generating a reasoning that arrives at a final solution, wherein the reasoning is subject to a user defined generative budget; and building, at a server the AI agent employing a trained first neural network based language model.

### CROSS REFERENCE(S)

The instant application is a nonprovisional of and claims priority under 35 U.S.C. 119 to U.S. provisional application No. 63/804,902, filed May 13, 2025, which is hereby expressly incorporated by reference herein in its entirety.

### TECHNICAL FIELD

The embodiments relate generally to machine learning systems for generative artificial intelligence (AI), and more specifically to systems and methods for building AI agents using reasoning language models.

### BACKGROUND

AI agents, commonly known as AI agents or virtual assistants, can be applied to a wide range of practical applications across various industries. In customer service, AI agents can handle user inquiries, provide support, and resolve issues 24/7, improving customer satisfaction and reducing operational costs. In healthcare, AI agents can offer initial consultations, answer health-related questions, and remind patients to take their medications. In the e-commerce sector, AI agents can assist with product recommendations, order tracking, and personalized shopping experiences. In information technology (IT) support, these agents can guide users through troubleshooting steps, helping them resolve software and hardware issues. Specifically, for network hazards, AI agents can diagnose connectivity problems, suggest corrective actions, and provide step-by-step guidance to ensure network security and stability. Their versatility and ability to handle diverse tasks make them valuable tools in enhancing efficiency and user experience in various fields.

AI agents often employ a neural network based generative language model to generate an output such as in the form of a text response, or a series actions to complete a complex task, such as to network issue troubleshooting, etc. Such generative language model receives a natural language input in the form of a sequence of tokens, and in turn generates a predicted distribution over a token space conditioned on the input sequence. Generated output tokens over time may in turn form the text response, or actions for completing the task. However, the output lengths of these AI agents can be uncontrolled, and this can pose challenges for real-world deployment.

### BRIEF DESCRIPTION OF THE DRAWINGS

FIG. 1 shows an exemplary application of an AI agent, according to some embodiments.

FIG. 2A is a simplified diagram showing a reinforcement learning (RL) framework for a LRM, according to some embodiments.

FIG. 2B is a simplified diagram illustrating an agentic framework according to some embodiments.

FIG. 3A is a simplified diagram illustrating a computing device implementing the agentic framework described in FIGS. 2A and 2B, according to some embodiments.

FIG. 3B is a simplified diagram illustrating a neural network structure, according to some embodiments.

FIG. 4 is a simplified block diagram of a networked system suitable for implementing the agentic framework described in FIGS. 2, 3A, and 3B and other embodiments described herein.

FIG. 5 is an example logic flow diagram illustrating a method of building an AI agent based on a large reasoning model (LRM), according to some embodiments.

FIGS. 6A-6H provide charts illustrating exemplary performance of different embodiments described herein.

Embodiments of the disclosure and their advantages are best understood by referring to the detailed description that follows. It should be appreciated that like reference numerals are used to identify like elements illustrated in one or more of the figures, wherein showings therein are for purposes of illustrating embodiments of the disclosure and not for purposes of limiting the same.

### DETAILED DESCRIPTION

As used herein, the term “network” may comprise any hardware or software-based framework that includes any artificial intelligence network or system, neural network or system and/or any training or learning models implemented thereon or therewith.

As used herein, the term “module” may comprise hardware or software-based framework that performs one or more functions. In some embodiments, the module may be implemented on one or more neural networks.

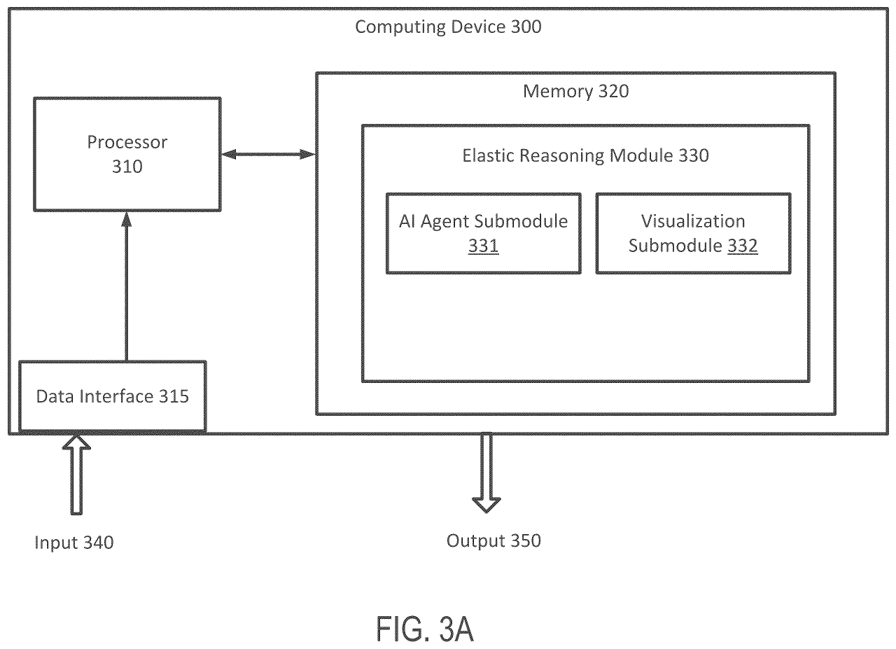

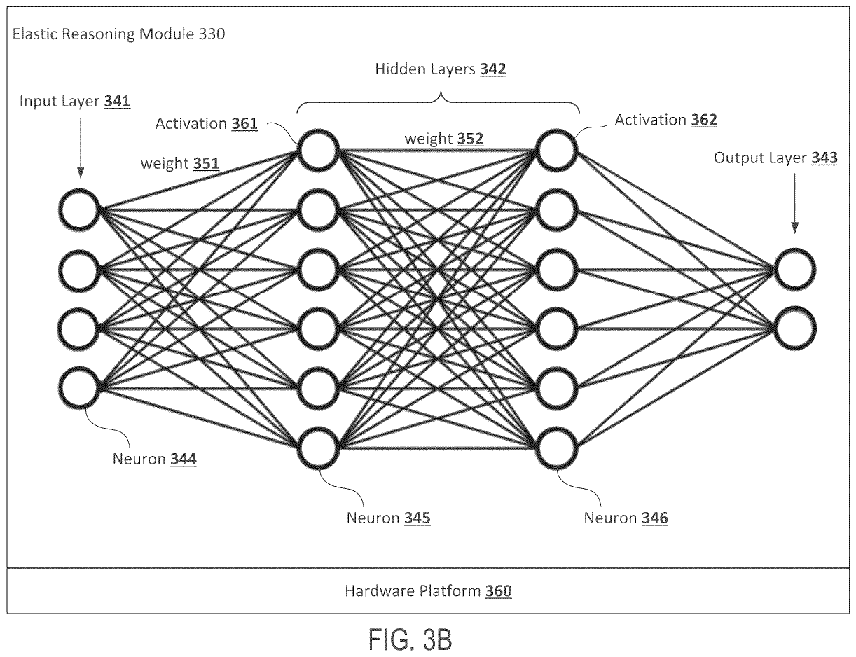

As used herein, the term “Transformer” may refer to an architecture of a deep learning model designed to process sequential data, such as text, using a mechanism called self-attention. The Transformer architecture handles an entire input sequence of tokens (such as words, letters, symbols, etc.) in parallel, and often generate an output sequence of tokens sequentially. The Transformer architecture may comprise a stack of Transformer layers, each of which contains a self-attention module to weigh the importance of each token relative to other tokens in the sequence and a feed-forward module to further transform the data. Additional details of how a Transformer neural network model processes input data to generate an output is provided in relation to FIG. 3B.

As used herein, the term “Large Language Model” (LLM) may refer to a neural network based deep learning system designed to understand and generate human languages. An LLM may adopt a Transformer architecture that often entails a significant amount of parameters (neural network weights) and computational complexity. For example, LLM such as Generative Pre-trained Transformer (GPT) 3 has 175 billion parameters, Text-to-Text Transfer Transformers (T5) has around 11 billion parameters. An LLM may comprise an architecture of mixed software and/or hardware, e.g., including an application-specific integrated circuit (ASIC) such as a Tensor Processing Unit (TPU).

As used herein, the term “generative artificial intelligence (AI)” may refer to an AI system that outputs new content that does not pr-exist in the input to such AI system. The new content may include text, images, music, or code. An LLM is an example generative AI model that generate tokens representing new words, sentences, paragraphs, passages, and/or the like that do not pre-exist in an input of tokens to such LLM. For example, when an LLM generate a text answer to an input question, the text answer contains words and/or sentences that are literally different from those in the input question, and/or carry different semantic meaning from the input question.

As used herein, the term “AI agent” may refer to a set of software and/or hardware that processes information from its environment and takes action to achieve specific goals such as executing a task. For example, an AI agent (like a chatbot or virtual assistant) might use an LLM as a component but also integrate tools like web browsing, APIs, databases, and other forms of reasoning to complete tasks.

### Overview

Large reasoning models (LRMs) are a type of LLMs that are used for generating step-by-step reasoning (e.g., referred to as a thinking part), that leads to a final answer (e.g., referred to as a solution part) to a query. However, the output length of a LRM is usually uncontrollable, leading to expensive generative budget (e.g., thousands of tokens generated for the thinking part) and therefore costly hardware and power consumption. Even when a user may set a generation budget (e.g., maximum length of output) for the LRM, the budget at most applies to the output final answer, but can hardly limit the length of the thinking part.

In view of the need for a LRM capable of generating output of controllable length, embodiments of the present disclosure provide a training framework that trains a LRM to generate an output within an output budget for efficient reasoning that arrives at a final answer. The LRM is then used to build an AI agent. The training framework May iteratively update the LRM in through reinforcement learning: within a fixed think phase budget and a fixed solution phase budget, the LRM may generate an output of the thinking part and the solution part in response to a training query. The generated solution part is then compared with the groundtruth answer to accord a reward. The reward may then be used to compute a gradient for the LRM to update its parameters, and iteratively generate a next reasoning. In this way, the LRM is iteratively updated to generate a reasoning under the output budget to result in a final answer that is close to or consistent with the ground-truth answer.

Optionally, given an output budget, training component 200 may update the allocation ratio between the thinking budget and the solution budget iteratively based on the gradient. A LRM may also be given a task of generating the budget allocation between the thinking part and the solution part, given the input query.

During inference, given an arbitrary output token budget (e.g., output budget) with a fixed solution phase budget (e.g., solution budget), the LRM can generate a thinking part that fits the output token budget.

Embodiments described herein provide a number of benefits. For example, AI-assisted chatbots, e.g., built on LRMs trained using the method provided by the present disclosure, can have controllable output lengths without sacrificing the accuracy of the final answer/solution. Therefore, with improved performance on AI agents based on LRMs of the present disclosure, neural network technology in healthcare, network issue support, or any other fields that use AI-assisted chatbots, is improved.

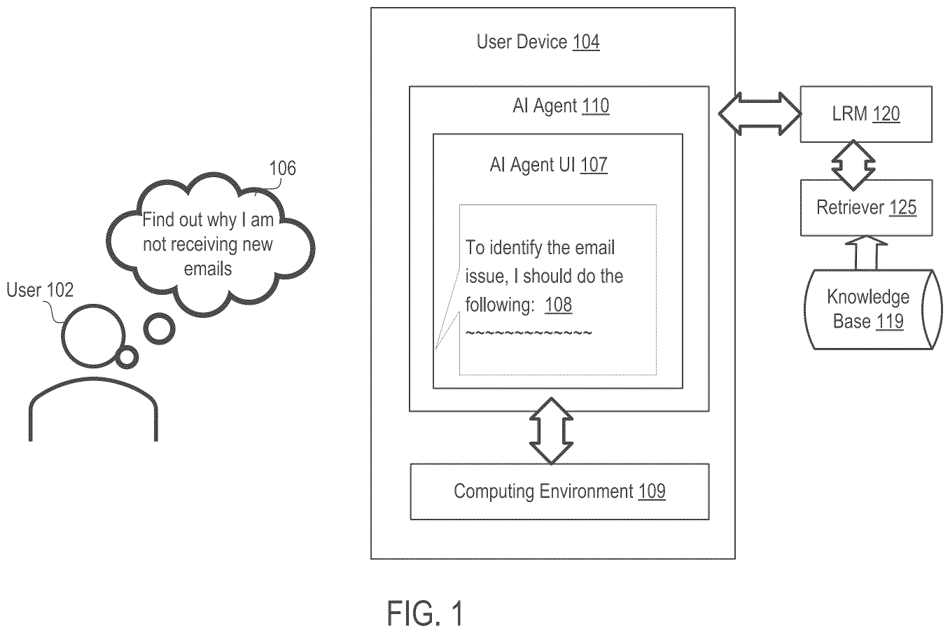

FIG. 1 shows an example operation of an LRM based AI agent, according to embodiments of the present disclosure. An LRM-based AI agent 110 may be implemented on a user device 104 to receive a user task request 106 as a natural language input, typically through a chat or command interface 107. This request 106 may range from simple queries to more complex tasks like data analysis, automation, or even generating content. For example, the user 102 may ask the AI agent to “find out why I am not receiving new emails” 106.

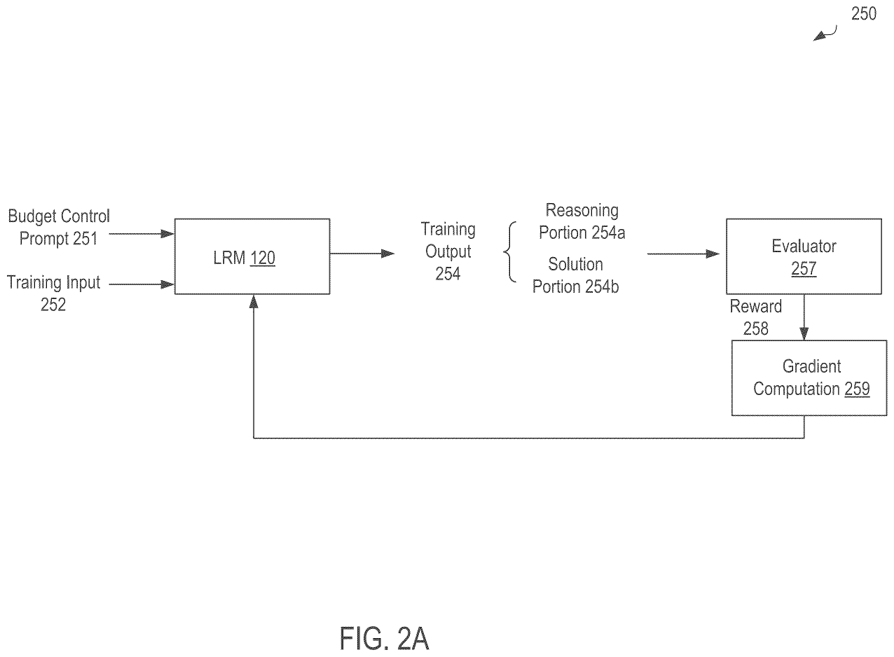

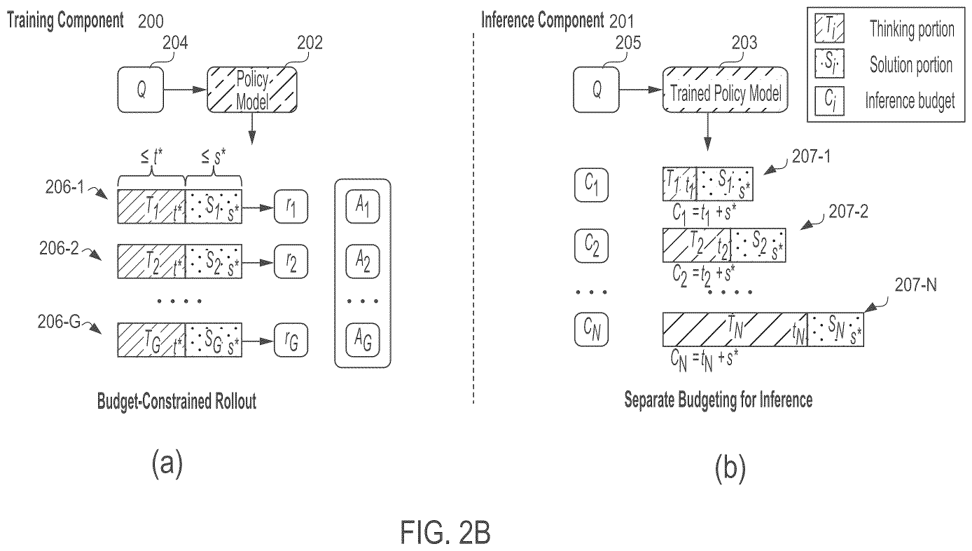

In one embodiment, the AI agent 110 may process the task request 106 at an LRM 120 to understand its intent, extracting key information such as the task type, desired outcome, and any specific constraints in order to generate a response. The LRM 120 may be hosted at an external server, a cloud service, and/or the like that is accessible by a communication network. In a different implementation, the LRM 120 may be hosted on the user device 104. An input to the LRM 120 may comprise the task request 106 and instruction provided to the LRM 120 to guide its behavior or responses in a particular way, referred to as a “system prompt.” For example, the system prompt may contain instruction for the LRM 120 to analyze the input and respond according to the request identified in the input, and generate an output in a certain format, e.g., suggested code program, text description, etc. The LRM 120 may in turn generate a response including a reasoning 108 in response to the request 106 based on an input combining the task request 106 and any system prompt. The LRM 120 may operate with a retriever model 125, which retrieves relevant context documents from a knowledge base 119 as a context, to in turn generate a textual response 108 based on an input combining the task request 106, any system prompt and the retrieved context. Additional details on the LRM 120 generating output tokens to form the response 108 may be described in FIGS. 2A and 2B.

The response 108 may include instructions, explanations, code scripts or direct actions to address the task request 106. Such response 108 may be displayed via the AI agent interface 107 for transparency. The response 108 may further include a reasoning output that leads to the final answer, such as the intermediate logical or explanatory steps the model produces (or simulates) when answering a question 106. In this example, in response to user request 106, the LRM 120 may reasoning steps that understand the problem (e.g., technical issues, configuration problems, or external factors), check common causes (e.g., the email account be out of storage, internet connection, emails being marked as spam or blocked by filters, etc.), account and server issues, device and app issues and/or next step recommendation (e.g., checking the spam folder, verifying account credentials, testing the email on another device, or contacting the email provider).

In addition to a text response 108 that describes how to fulfill the task request (e.g., suggesting a user 102 to perform diagnostic actions), the LRM 120 may generate computer-executable commands (e.g., system-level commands, Python scripts, etc.) that can directly trigger actions and/or interactions with the computing environment 109 on the user device 104, e.g., to check the spam folder of an email application, verify account credentials, send a testing email, and/or the like.

Additionally, the LRM 120 may output a code script to execute on the computing environment 109 (such as a network management application) on the user device 104 to retrieve network traffic log, analyze the traffic log, identify anomaly, and/or interface with APIs of other applications to send system command to a network device such as a gateway to update settings and/or run a code script to diagnose, and/or the like.

In this way, the LRM-based AI agent may facilitate end-to-end workflow to automate the task request 106. However, the output of the AI agent 110 can contain a reasoning portion that can often be uncontrollably long (e.g., approximately 90% of the total output tokens) tokens for the reasoning for a simple question such as “how much is five times four?”). Without placing control over the total token budget for reasoning, the LRM generation can be computationally consuming. When the user 102 is charged by a service provider on a per-token basis, such generation can be excessively expensive.

In this disclosure, it is assumed that the output LRM 120 (e.g., training output 254) includes two distinct segments: a reasoning portion (e.g., 254a, or thinking portion) and a solution portion (e.g., 254b). The reasoning portion may be referred to as the reasoning phase of the output and may be denoted using special tokens such as <think> and </think> to explicitly mark the LRM's intermediate thoughts. The solution portion may be referred to as the solution phase of the output, and may include a final answer summarized based on the reasoning phase.

For example, given an input prompt x, LRM 120 generates an output sequence (e.g., 254) y=(y^{think}, y^{solution}), where y^{think} (reasoning portion) contains the intermediate reasoning steps (enclosed in a think block between special tokens <think> and </think>) and y^{solution} (solution portion) contains the solution. Sometimes, y^{think} can account for over 90% of the total tokens, while y^{solution} provides a concise summary and the final answer. The overall generation structure can be denoted as:
y=(<think> intermediate reasoning </think >, solution)

In many real-world applications, it is desired that inference cost be carefully controlled due to constraints on latency, computation, or memory. An existing approach is to truncate generation after a fixed number of tokens c, enforcing:

|y|≤c

where |y| denotes the number of generated tokens. However, naively truncating the output often results in incomplete or missing y^{solution} leading to invalid or unusable predictions.

To address this limitation, the present disclosure provides a RL framework 250, which explicitly allocates independent budgets for the reasoning and solution phases.

FIG. 2A is a simplified diagram illustrating a reinforcement learning (RL) framework 250 for LRM 120 with elastic reasoning, according to embodiments described herein. As used herein, the LRM 120 may be iteratively updated for elastic reasoning, e.g., to generate output tokens containing a reasoning part subject to a controllable generative budget. The generative budget may take a form as, but not limited to, the maximum number of tokens, the maximum number of processor cycles, the maximum memory usage, the maximum time of generation, or other types of resources, and/or the like.

In the training process, LRM 120 may receive a budget control prompt 251 and a training input 252 as input, and may generate a training output 254. Budget control prompt 251 may include instructions that limit the output budget of training output 254. Training input 252 may include a training query Q (e.g., 204 in FIG. 2B). Training output 254 may include a reasoning portion 254a and a solution portion 254b. Training output 254 may be compared by an evaluator 257 to determine if it matches the groundtruth. In some embodiments, evaluator 257 can be a human and/or another LLM. Evaluator 257 may assign a reward 258 based on training output 254 and the policy of LRM 120. The reward 258 may be used to compute an expected return. A gradient computation 259 is performed to compute a training objective that includes the gradient of the expected return. The parameters of LRM 120 may then be updated based on the training objective. Details are described in FIG. 2B.

Therefore, according to the RL framework 250, even when the reasoning phase is forcibly terminated (e.g., by inserting </think>) when the thinking budget is reached, the trained LRM 120 is still capable of producing a coherent—and often correct—solution at inference.

For example, a total output budget c for the output of LRM 120 may be divided into two components: a thinking budget t for the thinking phase and a solution budget s for the solution phase, such that c=t+s. Thinking budget t and solution budget s may also be referred to as generative budgets. FIG. 2B shows the training and inference of LRM 120 with a output budget c. For ease of description, the budget of the example shown in FIG. 2B refers to the number of tokens.

In one embodiment, during the training shown in FIG. 2A, the allocation ratio between the thinking budget and solution budget may be pre-determined, e.g., heuristically based on empirical data. In some cases, the allocation ratio may be dynamically assigned, e.g., programmatically by a Python script, or by an LLM with a system prompt, based on a type of the user question. For example, the LLM may preliminarily assess the complexity of the user question, and dynamically increase or decrease the thinking budget. In another implementation, the allocation ratio between the thinking budget and solution budget may be a tunable parameter—given a total output budget, the allocation ratio may be updated based on the gradient based on backpropagation.

FIG. 2B shows a training component 200 and an inference component 201 of the RL framework 250. The training component 200 may train LRM 120, and the inference component 201 may build an AI agent based on the trained LRM 120, and performs inference tasks using the trained LRM 120, according to embodiments of the present disclosure.

A reinforcement learning (RL) fine-tuning may be used to train the LRM 120 under reasoning budgets, allowing the LRM 120 to produce more effective and concise reasoning within limited budgets.

Group relative policy optimization (GRPO) may be adopted as the RL algorithm for training process 200. The policy model 202 of the LRM 120, parameterized by θ, may be denoted as π_{θ}. The policy model 202 may generate an output, e.g., a response y=(y^{think} y^{solution}), for a given input x. The reasoning portion y^{think} is subject to a thinking budget of t* tokens, and the solution portion y^{solution} is subject to a solution budget of s* tokens. The output of policy model 202 is subject to an output budget of c* tokens, with t*+s*=c*.

A training dataset including one or more pairs of (training query Q groundtruth answer) may be used for training the LRM 120 by training component 200. The groundtruth answer (e.g., 256) may include the correct answer for the solution portion. During training, as shown in (a) of FIG. 2B, the LRM 120 may receive the training query Q 204 as the input and may generate a training output 206 that includes a reasoning portion and a solution portion. In some embodiments, training output 206 may include a plurality of trajectories 206-1, 206-2, . . . , 206-G, corresponding to the same training input Q 204. For each trajectory, policy model 202 may roll out a reasoning portion y^{think} up to the thinking budget of t* tokens. In some embodiments, if policy model 202 generates the </think> token before reaching the t* tokens, policy model 202 proceeds to generate the solution portion y^{solution} based on y^{think}, e.g., the complete reasoning portion. In some embodiments, if policy model 202 continues to generate tokens even after reaching the solution budget of t* tokens, the </think> token is forcibly appended once the thinking budget t* is reached. The policy model 202 may then generate the solution portion y^{solution} based on y^{think}, e.g., the incomplete reasoning portion. In some embodiments, y^{solution} is generated within the solution budget of s* for each trajectory.

For example, as shown in (a) of FIG. 2B, each trajectory i may include a thinking portion Tᵢ (y^{think}) and a solution portion Sᵢ (y^{solution}). The number of tokens in each portion may not exceed the respective budget (t* and s*). Based on the solution portion Sᵢ, a reward rᵢ may be computed and assigned to each trajectory, by a human evaluator or a LLM evaluator. Let r(y) denote a task-specific reward function. The value of reward rᵢ may be dependent on the comparison between solution Sᵢ and the groundtruth answer. For example, if Sᵢ matches the groundtruth answer, reward rᵢ is 1. Otherwise, reward rᵢ is 0. The expected return may be computed based on the reward rᵢ over a period of time, denoted in Eqn (1):

$$J ( θ ) = {𝔼}_{x ∼ 𝒟 , y ∼ {π}_{θ} ( \cdot \vert x ; t * , s \text{*)}} [ r ( y ) ] \qquad ( 1 )$$

The training objective, denoted in Eqn (2) and computed in loss computation 258, may be to maximize the expected return J(θ) using GRPO with the following gradient estimator:

$$\begin{matrix}{∇}_{θ} J ( θ ) = {𝔼}_{x , y} [ A ( x , y ) {∇}_{θ} log {π}_{θ} ( y \vert x ; t * , s \text{*)} ] \\ A ( x , y ) = \frac{r ( y ) - {𝔼}_{{y}^{′} ∼ {π}_{θ} ( \cdot \vert x ; t * , s \text{*)}} [ r ( {y}^{′} ) ]}{\sqrt{{{𝕍}_{y ′ ∼ {π}_{θ} ( \cdot \vert}}_{x )} [ r ( {y}^{′} ) ]}}\end{matrix} \qquad ( 2 )$$

The parameters θ of policy model 202 may be updated based on the gradient of the expected return, e.g., ∇_{θ}J(θ). The updated policy model 202 may then generate a refined training output. By iteratively updating parameters θ, policy model 202 may learn to generate solution portion y^{solution} that matches the groundtruth answer based on complete or incomplete reasoning portion y^{think}, improving the LRM 120's robustness to truncated thinking and reliability under tight resource constraints.

In some embodiments, during training, given an output budget c*, the LRM 120 may update the allocation ratio iteratively between the thinking budget t* and the solution budget s* based on the gradient of the expected return. In some embodiments, the LRM 120 is given a task of generating the budget allocation between the thinking budget t* and solution budget s* given an input query.

The thinking budget t* and the solution budget s* may have the same number of tokens or different numbers of tokens. In an example training setup, the budget pair may be fixed as (t*, s*)=(1K, 1K), as shown in (a) of FIG. 2B. The budget pair may be determined by the LRM 120. It is found that the learned policy generalizes well to a wide range of unseen budget configurations at test time, without requiring any additional fine-tuning. In some embodiments, the training query Q 204 includes a math reasoning question, and the groundtruth answer includes a math solution. In some embodiments, the training query Q 204 includes a code reasoning question, and the groundtruth answer includes a code snippet.

In some embodiments, this RL-based adaptation/learning helps the model prioritize informative reasoning content earlier in the generation process, thereby improving both robustness and solution quality under test-time truncation.

During inference, as shown in (b) of FIG. 2B, inference component 201 may provide arbitrary output budgets c₁, c₂, . . . , c_{N} to the trained policy model 203 of the LRM 120 for generating outputs 207-1, 207-2, . . . , 207-N when receiving an input query 205. In some embodiments, a user defines c₁, c₂, . . . , and/or c_{N}, e.g., with input query 205 in an input prompt provided to the trained LRM 120. In some embodiments, the trained LRM 120 may generate c₁, c₂, . . . , and/or c_{N}, e.g., based on input query Q 205. The trained LRM 120 may generalize to the arbitrary budgets as: cᵢ=tᵢ+s*, enabling flexible and efficient reasoning. That is, for each output budget cᵢ, the trained LRM 120 may generate a respective output 207-i that includes a thinking/reasoning portion y^{think} within the respective thinking budget tᵢ, and a solution portion y^{solution} within the respective solution budget. In some embodiments, the solution budgets for each output is set to be a fixed value s*. In some embodiments, the solution budgets for an output is different from that for another output. In various embodiments, tᵢ may be different from one another. In some embodiments, the trained LRM 120 determines t* based on input query Q 205. In various embodiments, solution budget s* may be defined by the trained LRM 120 or a user. The allocation of output budget c*, thinking budget t*, and/or solution budget s* based on input query indicates that the LRM 120 may internalize a flexible reasoning strategy that adapts to different resource constraints.

For example, the trained LRM 120 may begin generating the reasoning portion Tᵢ (y^{think}) within a <think> block. If the trained LRM 120 generates special token </think> before reaching the thinking budget tᵢ, the trained LRM 120 immediately transitions to the solution phase (e.g., starts generating solution portion y^{solution}). If the thinking budget tᵢ is exhausted before </think> is generated, the trained LRM 120 may terminate the reasoning phase by appending </think> once thinking budget tᵢ is reached. The trained LRM 120 may then continue generating the solution portion Sᵢ (y^{solution}), up to a maximum of s* tokens. In some embodiments, the trained LRM 120 generates a complete reasoning portion within thinking budget tᵢ. The trained LRM 120 may then be used to build an AI agent at a server.

Training component 200 and inference component 201 may ensure that both the reasoning and solution components are accommodated within the output budget c, thereby avoiding unintended truncation of the thinking phase. The thinking budget t can be flexibly adjusted at inference to match different application scenarios, while the solution phase may retain a guaranteed allocation s*. By dedicating a fixed token budget for solution generation, the RL framework 250 may significantly improve the reliability and quality of model outputs under tight inference-time constraints.

### Computer and Network Environment

FIG. 3A is a simplified diagram illustrating a computing device implementing the agentic framework described in FIG. 2B, according to one embodiment described herein. As shown in FIG. 3A, computing device 300 includes a processor 310 coupled to memory 320. Operation of computing device 300 is controlled by processor 310. And although computing device 300 is shown with only one processor 310, it is understood that processor 310 may be representative of one or more central processing units, multi-core processors, microprocessors, microcontrollers, digital signal processors, field programmable gate arrays (FPGAs), application specific integrated circuits (ASICs), graphics processing units (GPUs) and/or the like in computing device 300. Computing device 300 may be implemented as a stand-alone subsystem, as a board added to a computing device, and/or as a virtual machine.

Memory 320 may be used to store software executed by computing device 300 and/or one or more data structures used during operation of computing device 300. Memory 320 may include one or more types of machine-readable media. Some common forms of machine-readable media may include floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Processor 310 and/or memory 320 may be arranged in any suitable physical arrangement. In some embodiments, processor 310 and/or memory 320 may be implemented on a same board, in a same package (e.g., system-in-package), on a same chip (e.g., system-on-chip), and/or the like. In some embodiments, processor 310 and/or memory 320 may include distributed, virtualized, and/or containerized computing resources. Consistent with such embodiments, processor 310 and/or memory 320 may be located in one or more data centers and/or cloud computing facilities.

In another embodiment, processor 310 may comprise multiple microprocessors and/or memory 320 may comprise multiple registers and/or other memory elements such that processor 310 and/or memory 320 may be arranged in the form of a hardware-based neural network, as further described in FIG. 3B.

In some examples, memory 320 may include non-transitory, tangible, machine readable media that includes executable code that when run by one or more processors (e.g., processor 310) may cause the one or more processors to perform the methods described in further detail herein. For example, as shown, memory 320 includes instructions for elastic reasoning module 330 that may be used to implement and/or emulate the systems and models, and/or to implement any of the methods described further herein. Elastic reasoning module 330 may receive input 340 such as an input training data (e.g., pairs of (training query, groundtruth answer)) via the data interface 315 and generate an output 350 which may be a training output that includes a reasoning portion and a solution portion.

The data interface 315 may comprise a communication interface, a user interface (such as a voice input interface, a graphical user interface, and/or the like). For example, the computing device 300 may receive the input 340 (such as a training dataset) from a networked database via a communication interface. Or the computing device 300 may receive the input 340, such as pairs of (training query, groundtruth answer), from a user via the user interface.

In some embodiments, the elastic reasoning module 330 is configured to train a LRM (e.g., 120), build an AI agent based on the trained LRM, and visualize any data associated with the training and/or operations of the AI agent. The elastic reasoning module 330 may include an AI agent submodule 331 (e.g., similar to training component 200 and inference component 201 in FIG. 2B). AI submodule 331 may be configured to train a LRM to generate a solution portion that matches the groundtruth answer based on a complete or incomplete reasoning portion. AI submodule 331 may also be configured to build an AI agent based on the trained LRM, and generate an output with a reasoning portion and a solution portion when given an inference task. In some embodiments, AI submodule 331 adjusts the thinking budget for the reasoning portion based on the inference task. Elastic reasoning module 330 may further include a visualization submodule 332 configured to display any data, e.g., training data and/or inference data, to a user.

Some examples of computing devices, such as computing device 300 may include non-transitory, tangible, machine readable media that include executable code that when run by one or more processors (e.g., processor 310) may cause the one or more processors to perform the processes of method. Some common forms of machine-readable media that may include the processes of method are, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

FIG. 3B is a simplified diagram illustrating the neural network structure implementing the elastic reasoning module 330 described in FIG. 3A, according to some embodiments. In some embodiments, the elastic reasoning module 330 and/or one or more of its submodules 331 and 332 may be implemented at least partially via an artificial neural network structure shown in FIG. 3B. The neural network comprises a computing system that is built on a collection of connected units or nodes, referred to as neurons (e.g., 344, 345, 346). Neurons are often connected by edges, and an adjustable weight (e.g., 351, 352) is often associated with the edge. The neurons are often aggregated into layers such that different layers may perform different transformations on the respective input and output transformed input data onto the next layer.

For example, the neural network architecture may comprise an input layer 341, one or more hidden layers 342 and an output layer 343. Each layer may comprise a plurality of neurons, and neurons between layers are interconnected according to a specific topology of the neural network topology. The input layer 341 receives the input data (e.g., 340 in FIG. 3A), such as pairs of (training query, groundtruth answer). The number of nodes (neurons) in the input layer 341 may be determined by the dimensionality of the input data (e.g., the length of a vector of the training query). Each node in the input layer represents a feature or attribute of the input.

The hidden layers 342 are intermediate layers between the input and output layers of a neural network. It is noted that two hidden layers 342 are shown in FIG. 3B for illustrative purpose only, and any number of hidden layers may be utilized in a neural network structure. Hidden layers 342 may extract and transform the input data through a series of weighted computations and activation functions.

For example, as discussed in FIG. 3A, the elastic reasoning module 330 receives an input 340 of an input query and transforms the input into an output 350 of an output that includes a reasoning portion and a solution portion. To perform the transformation, each neuron receives input signals, performs a weighted sum of the inputs according to weights assigned to each connection (e.g., 351, 352), and then applies an activation function (e.g., 361, 362, etc.) associated with the respective neuron to the result. The output of the activation function is passed to the next layer of neurons or serves as the final output of the network. The activation function may be the same or different across different layers. Example activation functions include but not limited to Sigmoid, hyperbolic tangent, Rectified Linear Unit (ReLU), Leaky ReLU, Softmax, and/or the like. In this way, after a number of hidden layers, input data received at the input layer 341 is transformed into rather different values indicative data characteristics corresponding to a task that the neural network structure has been designed to perform.

The output layer 343 is the final layer of the neural network structure. It produces the network's output or prediction based on the computations performed in the preceding layers (e.g., 341, 342). The number of nodes in the output layer depends on the nature of the task being addressed. For example, in a binary classification problem, the output layer may consist of a single node representing the probability of belonging to one class. In a multi-class classification problem, the output layer may have multiple nodes, each representing the probability of belonging to a specific class.

Therefore, the elastic reasoning module 330 and/or one or more of its submodules 331 and 332 may comprise the transformative neural network structure of layers of neurons, and weights and activation functions describing the non-linear transformation at each neuron. Such a neural network structure is often implemented on one or more hardware processors 310, such as a graphics processing unit (GPU). An example neural network may be DeepScaleR-1.5B-Preview, DeepCoder-14B-Preview, DeepSeekR1-Distill-Qwen-1.5B, DeepSeekR1-Distill-Qwen-14B, and/or the like.

In one embodiment, the elastic reasoning module 330 and its submodules 331 and 332 may comprise one or more LLMs built upon a Transformer architecture. For example, the Transformer architecture comprises multiple layers, each consisting of self-attention and feedforward neural networks. The self-attention layer transforms a set of input tokens (such as words) into different weights assigned to each token, capturing dependencies and relationships among tokens. The feedforward layers then transform the input tokens, based on the attention weights, represents a high-dimensional embedding of the tokens, capturing various linguistic features and relationships among the tokens. The self-attention and feed-forward operations are iteratively performed through multiple layers of self-attention and feedforward layers, thereby generating an output based on the context of the input tokens. One forward pass for an input tokens to be processed through the multiple layers to generate an output in a Transformer architecture often entail hundreds of teraflops (trillions of floating-point operations) of computation.

For example, the Transformer-based architecture may process an input sequence of tokens (e.g., letters, symbols, numbers, signs, words, etc.) using its encoder-decoder architecture (for tasks such as machine translation, etc.) or just the encoder (for classification tasks) or decoder (for generation-only tasks). First, the input sequence may be tokenized and converted into embeddings, which are dense numerical representations, e.g., vectors of values. Positional encodings are added to these embeddings to provide information about the order of tokens.

The Transformer encoder, usually consisting of multiple layers, each of which may process the input using a multi-head self-attention mechanism to capture relationships between tokens and a feed-forward network to transform the information, resulting in encoded representations of the input sequence of tokens.

For example, the multi-head self-attention mechanism at each Transformer layer within the Transformer encoder of an LLM may project input embeddings at the layer into three different embedding spaces using weight matrices, referred to as Query (Q) representing what a token wants to attend to, Key (K) representing what this token offers as information and Value (V) representing the actual information carried by the token. The Q, K, V matrices contain tunable weights of a Transformer-based language model that are updated during training. Then, the attention mechanism computes attention scores between all tokens in the input sequence using the Q, K and V matrices. The resulting attention scores are then used to generate encoded representations of the input sequence of tokens.

Similarly, the Transformer decoder may comprise a symmetric structure with the encoder, consisting of multiple layers, each of which may comprise a multi-head self-attention mechanism. The decoder may start with a special start token and use the multi-head self-attention mechanism, augmented with encoder-decoder attention to focus on relevant parts of the decoder input. The decoder may generate output tokens one by one, with each step using the previously generated tokens as part of the input and updated attention weights. Finally, the decoder may comprise a linear layer and softmax function predict probabilities for the next token in the sequence, selecting the most likely one to continue the output. This process repeats until a special end token is generated or a length limit is reached.

The generated sequence of tokens may jointly represent an output. For example, a Transformer-based LLM (such as LLM 110a-d) may receive a natural language input (such as a question) and generate a natural language output (such as an answer to the question).

In one embodiment, the elastic reasoning module 330 and its submodules 331 and 332 may be implemented by hardware, software and/or a combination thereof. For example, the elastic reasoning module 330 and its submodules 331 and 332 may comprise a specific neural network structure implemented and run on various hardware platforms 360, such as but not limited to CPUs (central processing units), GPUs (graphics processing units), FPGAs (field-programmable gate arrays), Application-Specific Integrated Circuits (ASICs), dedicated AI accelerators like TPUs (tensor processing units), and specialized hardware accelerators designed specifically for the neural network computations described herein, and/or the like. Example specific hardware for neural network structures may include, but not limited to Google Edge TPU, Deep Learning Accelerator (DLA), NVIDIA AI-focused GPUs, and/or the like. The hardware 360 used to implement the neural network structure is specifically configured based on factors such as the complexity of the neural network, the scale of the tasks (e.g., training time, input data scale, size of training dataset, etc.), and the desired performance.

For example, to deploy the elastic reasoning module 330 and its submodules 331 and 332 and/or any other neural network models such as DeepScaleR-1.5B-Preview, DeepCoder-14B-Preview, DeepSeekR1-Distill-Qwen-1.5B, DeepSeekR1-Distill-Qwen-14B, described in FIG. 2B onto hardware platform 360, the neural network based modules 330 and its submodules 331 and 332 may be optimized for deployment by converting it to a suitable format, such as ONNX or TensorRT, to improve performance and compatibility. Next, depending on the size and workload requirements for module 330 and its submodules 331 and 332, hardware types may be chosen for deployment, e.g., processing capacity, GPU memory size, and/or the like. Frameworks and drivers for the chosen hardware 360 frameworks and drivers may thus be installed, such as PyTorch, TensorFlow, or CUDA, to support the hardware platform 360. Then, weights and parameters of the elastic reasoning module 330 and its submodules 331 and 332 may be loaded to the hardware 360. For large-scale deployments (e.g., with billions of weights for example), distributed computing frameworks may be used to handle model partitioning across multiple devices, e.g., hardware processors such as GPUs may be distributed on multiple devices, each handling a portion of weights of the model and therefore would undertake a portion of computational workload. In some embodiments, the elastic reasoning module 330 and its submodules 331 and 332 may be deployed as a service, then they may be integrated with an API endpoint, using tools like Flask, FastAPI, or a cloud platform serverless services, and is accessible by a remote user via a network.

In another embodiment, some or all of layers 341, 342, 343 and/or neurons 342, 345, 346, and operations there between such as activations 361, 362, and/or the like, of the elastic reasoning module 330 and its submodules 331 and 332 may be realized via one or more ASICs. For example, each neuron 342, 345 and 346 may be a hardware ASIC comprising a register, a microprocessor, and/or an input/output interface. For another example, operations among the neurons and layers may be implemented through an ASIC TPU. For yet another example, some operations among the neurons and layers such as a softmax operation, an activation function (such as a rectified linear unit (ReLU), sigmoid linear unit (SiLU), and/or the like) may be implemented by one or more ASICs.

For example, the elastic reasoning module 330 may generate, by at least one ASIC (such as a TPU, etc.) performing a multiplicative and/or accumulative operation for a neural network language model, a next token based at least in part on previously generated tokens, and in turn generate a natural language output representing the next-step action combining a sequence of generated tokens.

In one embodiment, the neural network based elastic reasoning module 330 and one or more of its submodules 331 and 332 may be trained by iteratively updating the underlying parameters (e.g., weights 351, 352, etc., bias parameters and/or coefficients in the activation functions 361, 362 associated with neurons) of the neural network based on the training objective in Eqn (2). For example, during forward propagation, the training data such as pairs of (training query, groundtruth answer) are fed into the neural network. The data flows through the network's layers 341, 342, with each layer performing computations based on its weights, biases, and activation functions until the output layer 343 produces the network's output 350. In some embodiments, output layer 343 produces an intermediate output on which the network's output 350 is based.

The output generated by the output layer 343 is compared to the expected output (e.g., a “ground-truth” such as the corresponding correct solution) from the training data, to compute a loss function that measures the discrepancy between the predicted output and the expected output. For example, the training objective may be based on a gradient of incurring return over a period of time. Given the loss, the negative gradient of the loss function is computed with respect to each weight of each layer individually. Such negative gradient is computed one layer at a time, iteratively backward from the last layer 343 to the input layer 341 of the neural network. These gradients quantify the sensitivity of the network's output to changes in the parameters. The chain rule of calculus is applied to efficiently calculate these gradients by propagating the gradients backward from the output layer 343 to the input layer 341.

In one embodiment, the neural network based elastic reasoning module 330 and one or more of its submodules 331 and 332 may be trained using policy gradient methods, also referred to as “reinforcement learning” methods. For example, instead of computing a loss based on a training output generated via a forward propagation of training data, the “policy” of the neural network model, which is a mapping from an input of the current states or observations of an environment the neural network model is operated at, to an output of action. Specifically, at each time step, a reward is allocated to an output of action generated by the neural network model. The gradients of the expected cumulative reward with respect to the neural network parameters are estimated based on the output of action, the current states of observations of the environment, and/or the like, such as in Eqn. (2). These gradients guide the update of the policy parameters using gradient descent methods like stochastic gradient descent (SGD) or Adam. In this way, as the “policy” parameters of the neural network model may be iteratively updated while generating an output action as time progresses, the boundaries between training and inference are often less distinct compared to supervised learning—in other words, backward propagation and forward propagation may occur for both “training” and “inference” stages of the neural network mode.

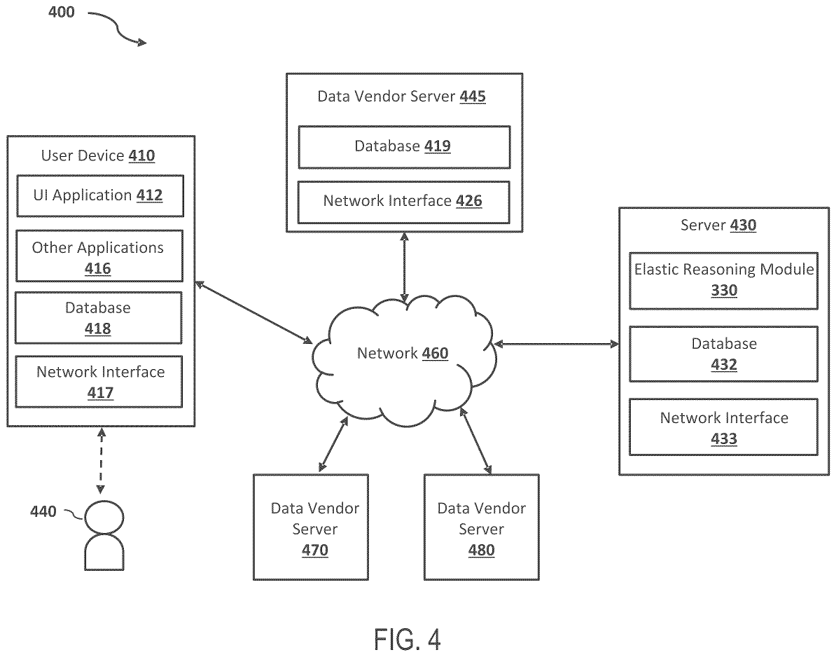

In some embodiments, elastic reasoning module 330 and its submodules 331 and 332 may be housed at a centralized server (e.g., computing device 300) or one or more distributed servers. For example, one or more of elastic reasoning module 330 and its submodules 331 and 332 may be housed at external server(s). The different modules may be communicatively coupled by building one or more connections through application programming interfaces (APIs) for each respective module. Additional network environment for the distributed servers hosting different modules and/or submodules may be discussed in FIG. 4.

During a backward pass, parameters of the neural network are updated backwardly from the last layer to the input layer (backpropagating) based on the computed negative gradient using an optimization algorithm to minimize the loss. The backpropagation from the last layer 343 to the input layer 341 may be conducted for a number of training samples in a number of iterative training epochs. In this way, parameters of the neural network may be gradually updated in a direction to result in a lesser or minimized loss, indicating the neural network has been trained to generate a predicted output value closer to the target output value with improved prediction accuracy. Training may continue until a stopping criterion is met, such as reaching a maximum number of epochs or achieving satisfactory performance on the validation data. At this point, the trained network can be used to make predictions on new, unseen data, such as generating an output in response to an input query. The output includes a reasoning portion and a solution portion

Neural network parameters may be trained over multiple stages. For example, initial training (e.g., pre-training) may be performed on one set of training data, and then an additional training stage (e.g., fine-tuning) may be performed using a different set of training data. In some embodiments, all or a portion of parameters of one or more neural-network model being used together may be frozen, such that the “frozen” parameters are not updated during that training phase. This may allow, for example, a smaller subset of the parameters to be trained without the computing cost of updating all of the parameters.

In some implementations, to improve the computational efficiency of training a neural network model, “training” a neural network model such as an LLM may sometimes be carried out by updating the input prompt, e.g., the instruction to teach an LLM how to perform a certain task. For example, while the parameters of the LLM may be frozen, a set of tunable prompt parameters and/or embeddings that are usually appended to an input to the LLM may be updated based on a training loss during a backward pass. For another example, instead of tuning any parameter during a backward pass, input prompts, instructions, or input formats may be updated to influence their output or behavior. Such prompt designs may range from simple keyword prompts to more sophisticated templates or examples tailored to specific tasks or domains.

In general, the training and/or finetuning of an LLM can be computationally extensive. For example, GPT-3 has 175 billion parameters, and a single forward pass using an input of a short sequence can involve hundreds of teraflops (trillions of floating-point operations) of computation. Training such a model requires immense computational resources, including powerful GPUs or TPUs and significant memory capacity. Additionally, during training, multiple forward and backward passes through the network are performed for each batch of data (e.g., thousands of training samples), further adding to the computational load.

In general, the training process transforms the neural network into an “updated” trained neural network with updated parameters such as weights, activation functions, and biases. The trained neural network thus improves neural network technology in healthcare, network issue diagnosis, etc.

FIG. 4 is a simplified block diagram of a networked system 400 suitable for implementing the agentic framework described in FIGS. 2, 3A, 3B and other embodiments described herein. In one embodiment, system 400 includes the user device 410 which may be operated by user 440, data vendor servers 445, 470 and 480, server 430, and other forms of devices, servers, and/or software components that operate to perform various methodologies in accordance with the described embodiments. Exemplary devices and servers may include device, stand-alone, and enterprise-class servers which may be similar to the computing device 300 described in FIG. 3A, operating an OS such as a MICROSOFT® OS, a UNIX® OS, a LINUX® OS, or other suitable device and/or server-based OS. It can be appreciated that the devices and/or servers illustrated in FIG. 4 may be deployed in other ways and that the operations performed, and/or the services provided by such devices and/or servers may be combined or separated for a given embodiment and may be performed by a greater number or fewer number of devices and/or servers. One or more devices and/or servers may be operated and/or maintained by the same or different entities.

The user device 410, data vendor servers 445, 470 and 480, and the server 430 may communicate with each other over a network 460. User device 410 may be utilized by a user 440 (e.g., a driver, a system admin, etc.) to access the various features available for user device 410, which may include processes and/or applications associated with the server 430 to receive an output data anomaly report.

User device 410, data vendor server 445, and the server 430 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 400, and/or accessible over network 460.

User device 410 may be implemented as a communication device that may utilize appropriate hardware and software configured for wired and/or wireless communication with data vendor server 445 and/or the server 430. For example, in one embodiment, user device 410 may be implemented as an autonomous driving vehicle, a personal computer (PC), a smart phone, laptop/tablet computer, wristwatch with appropriate computer hardware resources, eyeglasses with appropriate computer hardware (e.g., GOOGLE GLASS®), other type of wearable computing device, implantable communication devices, and/or other types of computing devices capable of transmitting and/or receiving data, such as an IPAD® from APPLE®. Although only one communication device is shown, a plurality of communication devices may function similarly.

User device 410 of FIG. 4 contains a user interface (UI) application 412, and/or other applications 416, which may correspond to executable processes, procedures, and/or applications with associated hardware. For example, the user device 410 may receive a message indicating training data from the server 430 and display the message via the UI application 412. In other embodiments, user device 410 may include additional or different modules having specialized hardware and/or software as required.

In one embodiment, UI application 412 may communicatively and interactively generate a UI for an AI agent implemented through the elastic reasoning module 330 (e.g., an LLM agent) at server 430. In at least one embodiment, a user operating user device 410 may enter a user utterance, e.g., via text or audio input, such as a question, uploading a document, and/or the like via the UI application 412. Such user utterance may be sent to server 430, at which elastic reasoning module 330 may generate a response via the process described in FIGS. 2 and 3A. The elastic reasoning module 330 may thus cause a display of output with a reasoning portion and a solution portion at UI application 412 and interactively update the display in real time with the user utterance.

In various embodiments, user device 410 includes other applications 416 as may be desired in particular embodiments to provide features to user device 410. For example, other applications 416 may include security applications for implementing client-side security features, programmatic client applications for interfacing with appropriate application programming interfaces (APIs) over network 460, or other types of applications. Other applications 416 may also include communication applications, such as email, texting, voice, social networking, and IM applications that allow a user to send and receive emails, calls, texts, and other notifications through network 460. For example, the other application 416 may be an email or instant messaging application that receives a prediction result message from the server 430. Other applications 416 may include device interfaces and other display modules that may receive input and/or output information. For example, other applications 416 may contain software programs for asset management, executable by a processor, including a graphical user interface (GUI) configured to provide an interface to the user 440 to view the output.

User device 410 may further include database 418 stored in a transitory and/or non-transitory memory of user device 410, which may store various applications and data and be utilized during execution of various modules of user device 410. Database 418 may store user profile relating to the user 440, predictions previously viewed or saved by the user 440, historical data received from the server 430, and/or the like. In some embodiments, database 418 may be local to user device 410. However, in other embodiments, database 418 may be external to user device 410 and accessible by user device 410, including cloud storage systems and/or databases that are accessible over network 460.

User device 410 includes at least one network interface component 417 adapted to communicate with data vendor server 445 and/or the server 430. In various embodiments, network interface component 417 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Data vendor server 445 may correspond to a server that hosts database 419 to provide training datasets including pairs of (training query, groundtruth answer) to the server 430. The database 419 may be implemented by one or more relational database, distributed databases, cloud databases, and/or the like.

The data vendor server 445 includes at least one network interface component 426 adapted to communicate with user device 410 and/or the server 430. In various embodiments, network interface component 426 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. For example, in one implementation, the data vendor server 445 may send asset information from the database 419, via the network interface 426, to the server 430.

The server 430 may be housed with the elastic reasoning module 330 and its submodules described in FIG. 3A. In some implementations, elastic reasoning module 330 may receive data from database 419 at the data vendor server 445 via the network 460 to generate outputs with reasoning portions and solution portions. The generated outputs may also be sent to the user device 410 for review by the user 440 via the network 460.

In one embodiment, an AI agent implementing the elastic reasoning module 330 and its submodules described in FIG. 3A may be built based on an LLM as described in FIG. 3B. For example, the AI agent may be configured with one or more LLMs (e.g., each pretrained for a specific task or domain), a plurality of system prompts, and connected to external APIs to databases and applications (e.g., a search engine, a cloud service, an internal database, etc.).

In some embodiments, the AI agent implementing the elastic reasoning module 330 and its submodules described in FIG. 3A may be implemented as a cloud-based AI agent which may be accessed by user device 410 via a chatbot application, a web application, customer support or SaaS applications. In another implementation, a client-side AI agent component may be delivered from the server 430 to user device 410 for local installation such that the client-side AI agent may be installed and runs directly on the user's device. Such local AI agent on the user device 410 may be available offline to adapt to privacy-sensitive applications. In another implementation, the AI agent implementing the elastic reasoning module 330 and its submodules described in FIG. 3A may adopt a hybrid cloud and client-based structure to balance computing speed, cost and privacy. For example, a local AI agent may handle basic AI queries locally, but complex queries may be sent to server 430 to process.

The database 432 may be stored in a transitory and/or non-transitory memory of the server 430. In one implementation, the database 432 may store data obtained from the data vendor server 445. In one implementation, the database 432 may store parameters of the elastic reasoning module 330. In one implementation, the database 432 may store previously generated training data, training output, and the corresponding input feature vectors.

In some embodiments, database 432 may be local to the server 430. However, in other embodiments, database 432 may be external to the server 430 and accessible by the server 430, including cloud storage systems and/or databases that are accessible over network 460.

The server 430 includes at least one network interface component 433 adapted to communicate with user device 410 and/or data vendor servers 445, 470 or 480 over network 460. In various embodiments, network interface component 433 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 460 may be implemented as a single network or a combination of multiple networks. For example, in various embodiments, network 460 may include the Internet or one or more intranets, landline networks, wireless networks, and/or other appropriate types of networks. Thus, network 460 may correspond to small scale communication networks, such as a private or local area network, or a larger scale network, such as a wide area network or the Internet, accessible by the various components of system 400.

### Example Work Flows

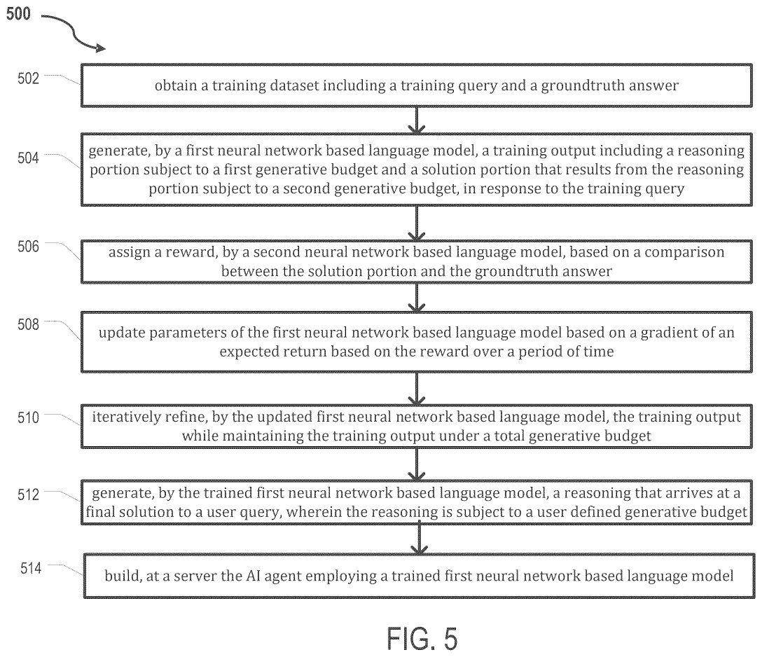

FIG. 5 is an example logic flow diagram illustrating a method of building an AI agent based on the agentic framework shown in FIG. 2B, according to some embodiments described herein. One or more of the processes of method 500 may be implemented, at least in part, in the form of executable code stored on non-transitory, tangible, machine-readable media that when run by one or more processors may cause the one or more processors to perform one or more of the processes. In some embodiments, method 500 corresponds to the operation of the elastic reasoning module 330 (e.g., FIGS. 3A and 4) that performs training a LRM, and building an AI agent based on the trained LRM.

In some embodiments, method 500 is performed by a system such as computing device 300, user device 410, server 430, or another device or combination of devices. Inputs (e.g., input query) may be received via a data interface such as data interface 315, network interface 417, network interface 433, or via a data interface that is integrated with a device. For example UI Application 412 may receive user inputs via a text input interface (e.g., keyboard), audio input (e.g., microphone), video interface (e.g., camera), or other interface for receiving user inputs (e.g., a mouse or touch display).

As illustrated, the method 500 includes a number of enumerated steps, but aspects of the method 500 may include additional steps before, after, and in between the enumerated steps. In some aspects, one or more of the enumerated steps may be omitted or performed in a different order.

At step 502, a training dataset (e.g., 251, 252, 204) including a training query (e.g., 204) and a groundtruth answer is obtained. In some embodiments, the training dataset includes a math reasoning query and a math answer, or a code reasoning query and a code snippet.

At step 504, a training output (e.g., 254) is generated by a first neural network based language model (e.g., 120, 202). The training output includes a reasoning portion (e.g., 254a) subject to a first generative budget (e.g., t*) and a solution portion (e.g., 254b) that results from the reasoning portion subject to a second generative budget (e.g., s*), in response to the training query.

In some embodiments, the first generative budget or the second generative budget includes at least one of a maximum number of tokens, a maximum number of processor cycles, a maximum memory usage, a maximum time of generation, or a combination thereof. In some embodiments, method 500 further includes allocating the first generative budget and the second generative budget from a total generative budget based on a tunable ratio. In some embodiments, the generating of the training output includes forcibly inserting a special token at an end of the first generative budget to discontinue the reasoning portion in response to the reasoning portion being incomplete at the end of the first generative budget. In some embodiments, the first generative budget is equal to the second generative budget in a training of the first neural network based language model.

At step 506, a reward (e.g., 258) is assigned by a second neural network based language model (e.g., 257) based on a comparison between the solution portion and the groundtruth answer.

At step 508, parameters of the first neural network based language model are updated based on a gradient (e.g., 259) of an expected return based on the reward over a period of time.

In some embodiments, the generating of the training output, the assigning the reward, and the updating of the parameters of the first neural network language model are based on a group relative policy optimization (GRPO).

At step 510, the training output is iteratively refined by the updated first neural network based language model while maintaining the training output under a total generative budget.

At step 512, a reasoning (e.g., t₁, t₂, . . . , t_{N}) that arrives at a final solution (e.g., 207-1, . . . , 207-N) to a user query (e.g., 205) is generated by the trained first neural network based language model (e.g., 203). The reasoning is subject to a user defined generative budget.

At step 514, the AI agent (e.g., 110) employing a trained first neural network based language model is built at a server.

In some embodiments, method 500 further includes: receiving an input query and a generative budget that is different from the first generative budget or the second generative budget; and generating, by the trained neural network based model, an output comprising a reasoning and a solution subject to the generative budget.

In some embodiments, method 500 is applicable in a variety of applications. For example, the task request received by a neural network model (e.g., DeepScaleR and/or DeepCoder) may relate to a diagnostic request in view of a medical record in a healthcare system, a curriculum designing request in an online education system, a code generation request in a software development system, a writing and/or editing request in a content generation system, an IT diagnostic request in an IT customer service support system, a navigation request in a robotic and autonomous system, and/or the like. By performing method 500, the neural network based artificial agent may improve technology in the respective technical field in healthcare and diagnostics, education and personalized learning, software development and code assistance, content creation, autonomous system (such as autonomous driving, etc.), and/or the like.

For example, when the task query includes a query to identify an information technology (IT) anomaly relating to a usage of an IT component such as a network gateway, a router, an online printer, and/or the like, by performing method 500 at an environment of a local area network (LAN), the neural network based artificial agent may receive an observation from the environment at which the next-step action is executed, and determine that the observation representing an information technology anomaly (e.g., a router failure, an unauthorized access attempt, a domain name system anomaly, and/or the like). In some implementations, the neural network based artificial agent may cause an alert relating to the information technology anomaly to be displayed at a visualized user interface. In this way, IT anomalies may be detected and alerted using the neural network based artificial agent in an efficient manner so as to improve network support technology.

### Example Results

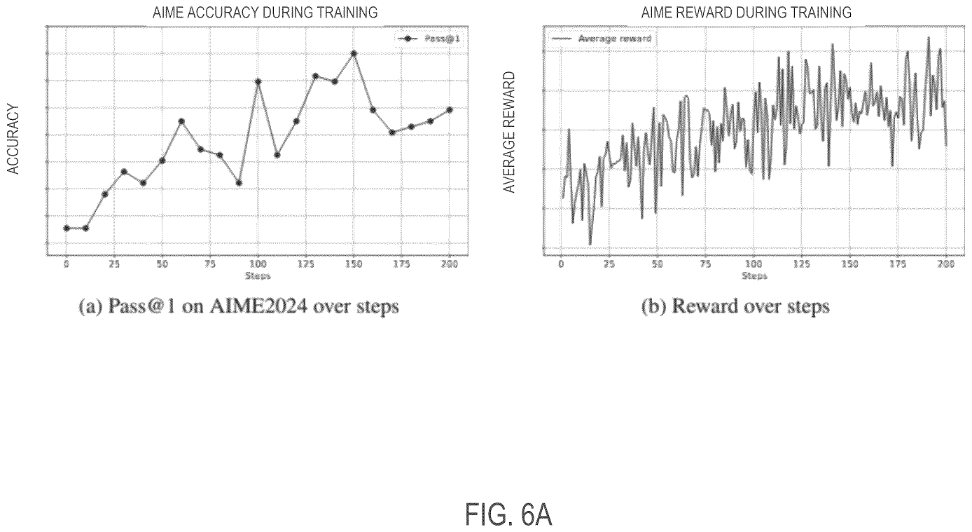

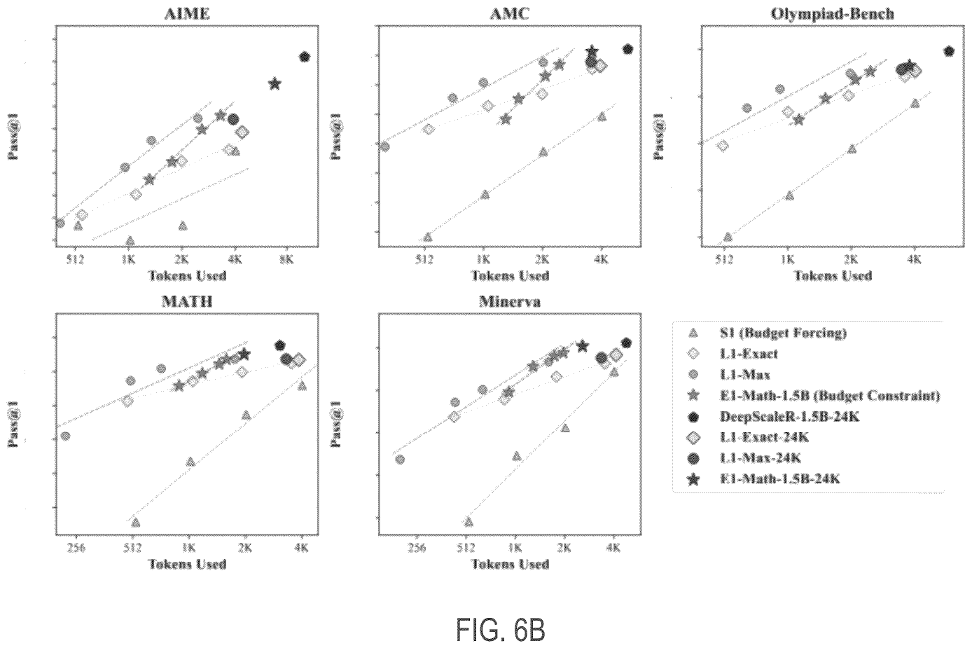

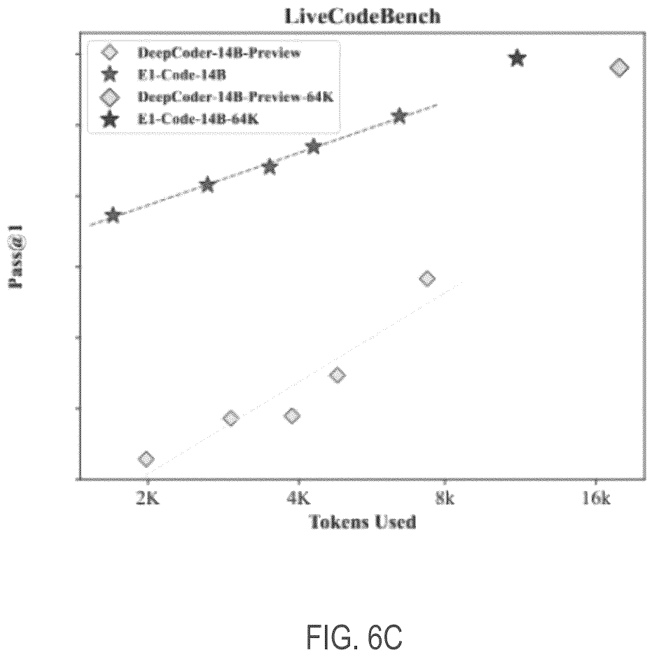

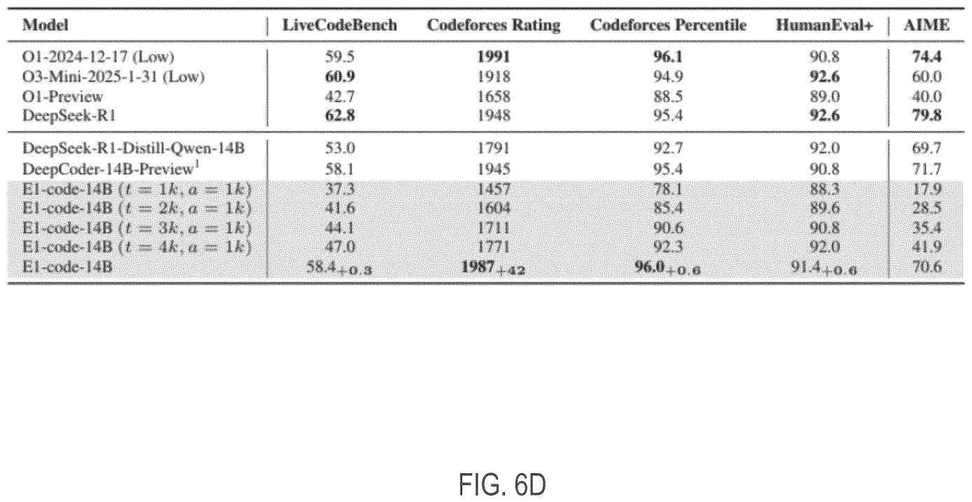

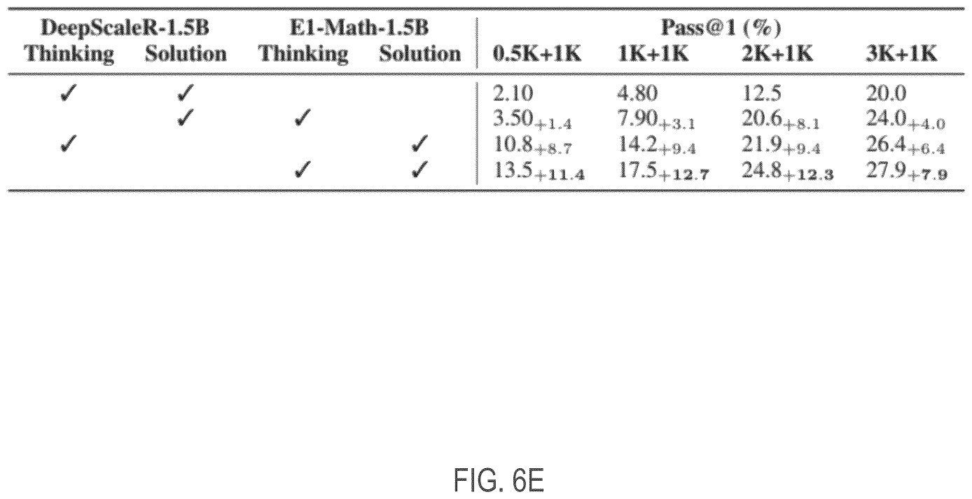

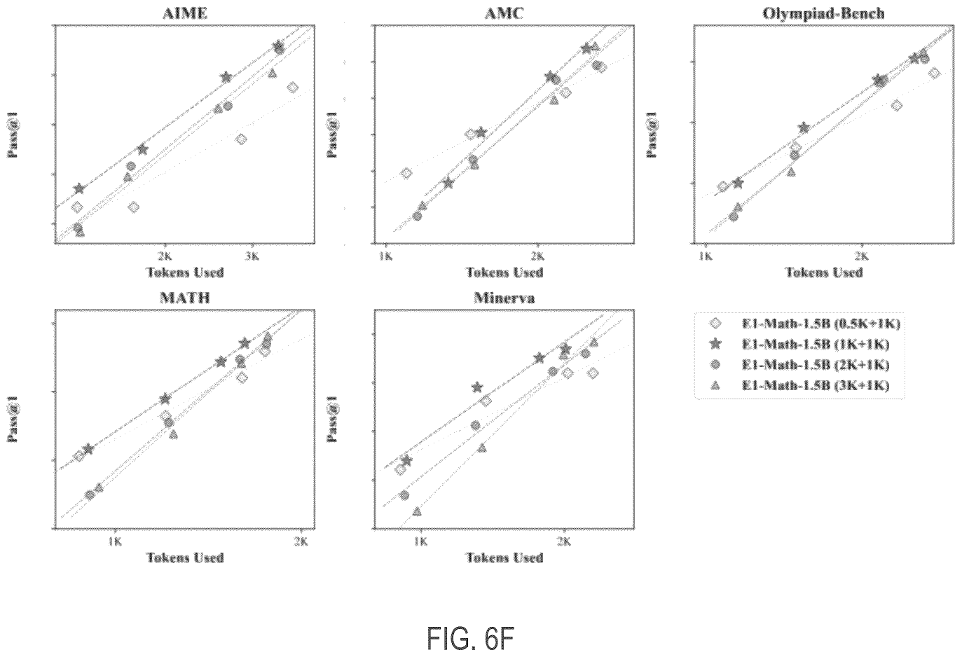

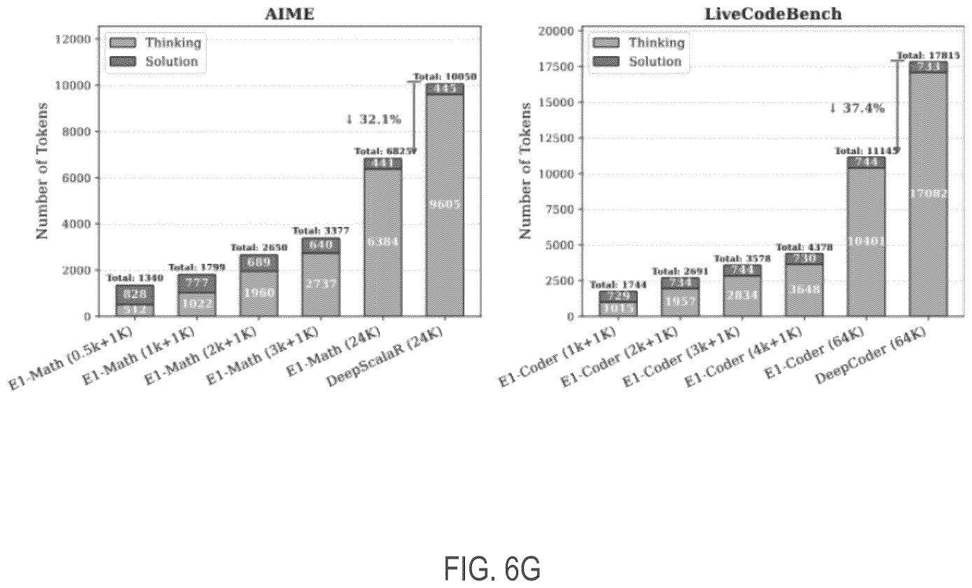

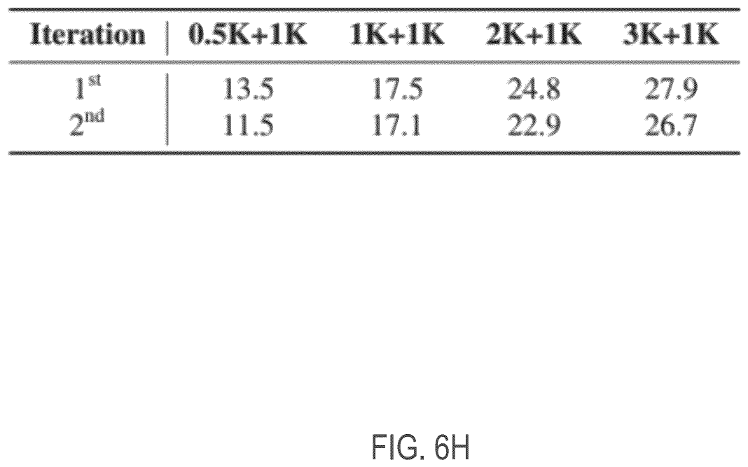

FIGS. 6A-6H represent exemplary test results using embodiments described herein.

Models and datasets used in the present disclosure are described as follows. The base models are DeepScaleR-1.5B-Preview (Michael Luo, Sijun Tan, Justin Wong, Xiaoxiang Shi, William Y. Tang, Manan Roongta, Colin Cai, et al. Deepscaler: Surpassing 01-preview with a 1.5 b model by scaling reinforcement learning, 2025) and DeepCoder-14B-Preview (Michael Luo, Xiaoxiang Shi Sijun Tan, Roy Huang, Rachel Xin, Colin Cai, Ameen Patel, Alpay Ariyak, Qingyang Wu, Ce Zhang, Li Erran Li, Raluca Ada Popa, and Ion Stoica. Deepcoder: A fully open-source 14b coder at o3-mini level), which are fine-tuned from DeepSeelcRI-Distill-Qwen-1.5B and 14B (DeepSeek-AI, Daya Guo, Dejian Yang, Haowei Zhang, Junxiao Song, Ruoyu Zhang, Runxin Xu, Qihao Zhu, Shirong Ma, Peiyi Wang, Xiao Bi, Xiaokang Zhang, Xingkai Yu, Yu Wu, Z. F. Wu, Zhibin Gou, Zhihong Shao, Zhuoshu Li, Ziyi Gao, Aixin Liu, Bing Xue, Bingxuan Wang, Bochao Wu, Bei Feng, Chengda Lu, Chenggang Zhao, Chengqi Deng, Chenyu Zhang, Chong Ruan, Damai Dai, Deli Chen, Dongjie Ji, Erhang Li, Fangyun Lin, Fucong Dai, Fuli Luo, Guangbo Hao, Guanting Chen, Guowei Li, II. Zhang, Han Bao, Hanwei Xu, Haochcng Wang, Honghui Ding, Huajian Xin, Huazuo Gao, Hui Qu, Hui Li, Jianzhong Guo, Jiashi Li, Jiawei Wang, Jingchang Chen, Jingyang Yuan, Junjie Qiu, Junlong Li, J. L. Cai, Jiaqi Ni, Jian Liang, Jin Chen, Kai Dong, Kai Hu, Kaige Gao, Kang Guan, Kexin Huang, Kuai Yu, Lean Wang, Lecong Zhang, Liang Zhao, Litong Wang, Liyue Zhang, Lei Xu, Leyi Xia, Mingchuan Zhang, Minghua Zhang, Minghui Tang, Meng Li, Miaojun Wang, Mingming Li, Ning Tian, Panpan Huang, Peng Zhang, Qiancheng Wang, Qinyu Chen, Qiushi Du, Ruiqi Ge, Ruisong Zhang, Ruizhe Pan, Runji Wang, R. J. Chen, R. L. Jin, Ruyi Chen, Shanghao Lu, Shangyan Zhou, Shanhuang Chen, Shengfeng Ye, Shiyu Wang, Shuiping Yu, Shunfeng Zhou, Shuting Pan, S. S. Li, Shuang Zhou, Shaoqing Wu, Shengfeng Ye, Tao Yun, Tian Pei, Tianyu Sun, T. Wang, Wangding Zeng, Wanjia Zhao, Wen Liu, Wenfeng Liang, Wenjun Gao, Wenqin Yu, Wcntao Zhang, W. L. Xiao, Wei An, Xiaodong Liu, Xiaohan Wang, Xiaokang Chen, Xiaotao Nie, Xin Cheng, Xin Liu, Xin Xie, Xingchao Liu, Xinyu Yang, Xinyuan Li, Xuecheng Su, Xuheng Lin, X. Q. Li, Xiangyue Jin, Xiaojin Shen, Xiaosha Chen, Xiaowen Sun, Xiaoxiang Wang, Xinnan Song, Xinyi Zhou, Xianzu Wang, Xinxia Shan, Y. K. Li, Y. Q. Wang, Y. X. Wei, Yang Zhang, Yanhong Xu, Yao Li, Yao Zhao, Yaofeng Sun, Yaohui Wang, Yi Yu, Yichao Zhang, Yifan Shi, Yiliang Xiong, Ying He, Yishi Piao, Yisong Wang, Yixuan Tan, Yiyang Ma, Yiyuan Liu, Yongqiang Guo, Yuan Ou, Yuduan Wang, Yue Gong, Yuheng Zou, Yujia He, Yunfan Xiong, Yuxiang Luo, Yuxiang You, Yuxuan Liu, Yuyang Zhou, Y. X. Zhu, Yanhong Xu, Yanping Huang, Yaohui Li, Yi Zheng, Yuchen Zhu, Yunxian Ma, Ying Tang, Yukun Zha, Yuting Yan, Z. Z. Ren, Zchui Ren, Zhangli Sha, Zhe Fu, Zhean Xu, Zhenda Xie, Zhengyan Zhang, Zhcwen Hao, Zhicheng Ma, Zhigang Yan, Zhiyu Wu, Zihui Gu, Zijia Zhu, Zijun Liu, Zilin Li, Ziwei Xie, Ziyang Song, Zizheng Pan, Zhen Huang, Zhipeng Xu, Zhongyu Zhang, and Zhen Zhang. Deepseek-rl: Incentivizing reasoning capability in Ums via reinforcement learning, 2025. URL https://arxiv.org/abs/2501.12948) through iterative context lengthening. For training data, the same datasets used in (Michael Luo, Sijun Tan, Justin Wong, Xiaoxiang Shi, William Y. Tang, Manan Roongta, Colin Cai, et al. Deepscaler: Surpassing O1-preview with a 1.5 b model by scaling reinforcement learning, 2025; Michael Luo, Xiaoxiang Shi Sijun Tan, Roy Huang, Rachel Xin, Colin Cai, Ameen Patel, Alpay Ariyak, Qingyang Wu, Ce Zhang, Li Erran Li, Raluca Ada Popa, and Ion Stoica. Deepcoder: A fully open-source 14b coder at o3-mini level) are followed. In the math domain, the training set consists of AIME (1984-2023), AMC, Omni-Math (Bofei Gao, Feifan Song, Zhe Yang, Zefan Cai, Yibo Miao, Qingxiu Dong, Lei Li, Chenghao Ma, Liang Chen, Runxin Xu, Zhengyang Tang, Benyon Wang, Daoguang Zan, Shanghaoran Quan, Gc Zhang, Lei Sha, Yichang Zhang, Xuancheng Ren, Tianyu Liu, and Baobao Chang. Omni-math: A universal olympiad level mathematic benchmark for large language models, 2024), and STILL (Yingqian Min, Zhipeng Chen, Jinhao Jiang, Jie Chen, Jia Deng, Yiwen Hu, Yiru Tang, Jiapeng Wang, Xiaoxue Cheng, Huatong Song, Wayne Xin Zhao, Zheng Liu, Zhongyuan Wang, and Ji-Rong Wen. Imitate, explore, and self-improve: A reproduction report on slow-thinking reasoning systems, 2024). For code training, TACO (Rongao Li, Jie Fu, Bo-Wen Zhang, Tao Huang, Zhihong Sun, Chen Lyu, Guang Liu, Zhi Jin, and Ge Li. Taco: Topics in algorithmic code generation dataset, 2023), SYNTHETIC-1 (Justus Mattern, Sami Jaghouar, Manveer Basra, Jannik Straube, Matthew Di Ferrante, Felix Gabriel, Jack Min Ong, Vincent Weisser, and Johannes Hagemann. Synthetic-1: Two million collaboratively generated reasoning traces from deepseek-rl, 2025), and LiveCodeBench (2023 May 1-2024 Jul. 31) (Naman Jain, King Han, Alex Gu, Wen-Ding Li, Fanjia Yan, Tianjun Zhang, Sida Wang, Armando Solar-Lezama, Koushik Sen, and Ion Stoica. Livecodebench: Holistic and contamination free evaluation of large language models for code, 2024) are used. For evaluation, AIME 2024, MATH500 (Dan Hendrycks, Collin Burns, Saurav Kadavath, Akul Arora, Steven Basart, Eric Tang, Dawn Song, and Jacob Steinhardt. Measuring mathematical problem solving with the math dataset, 2021), AMC, Olympiad-Bench (Bofei Gao, Feifan Song, Zhe Yang, Zefan Cai, Yibo Miao, Qingxiu Dong, Lei Li, Chenghao Ma, Liang Chen, Runxin Xu, Zhengyang Tang, Benyon Wang, Daoguang Zan, Shanghaoran Quan, Gc Zhang, Lei Sha, Yichang Zhang, Xuancheng Ren, Tianyu Liu, and Baobao Chang. Omni-math: A universal olympiad level mathematic benchmark for large language models, 2024), and Minerva Math (Aitor Lewkowycz, Anders Andreassen, David Dohan, Ethan Dyer, Henryk Michalewski, Vinay Ramasesh, Ambrose Slone, Cem Anil, Imanol Schlag, Theo Gutman-Solo, et al. Solving quantitative reasoning problems with language models, 2022) are used for mathematical reasoning. For code-related tasks, LiveCodeBench (2024 Aug. 1 2025 Feb. 1) (Naman Jain, King Han, Alex Gu, Wen-Ding Li, Fanjia Yan, Tianjun Zhang, Sida Wang, Armando Solar-Lezama, Koushik Sen, and Ion Stoica. Livecodebench: Holistic and contamination free evaluation of large language models for code, 2024), Codeforces, and HumanEval+ (Jiawei Liu, Chunqiu Steven Xia, Yuyao Wang, and Lingming Zhang. Is your code generated by chatGPT really correct? rigorous evaluation of large language models for code generation, 2023) are evaluated.

For GRPO training, the same hyperparameters as those used in DeepScaleR-1.5B-Preview and DeepCode-14B-Preview are adopted. For El-Math-1.5B, a learning rate of 1×10⁻⁶ and a batch size of 128 is used. The maximum context length is set to 1K tokens for the thinking segment and 1K tokens for the solution segment. Training is performed for 200 steps using the VeRL (Guangming Sheng, Chi Zhang, Zilingfeng Ye, Xibin Wu, Wang Zhang, Ru Zhang, Yanghua Peng, Haibin Lin, and Chuan Wu. Hybridflow: A flexible and efficient rlhf framework, 2024) framework. For E1-Code-14B, the same learning rate and batch size is used. The context length configuration mirrors that of the math model: 1K tokens for thinking and 1K tokens for solution. Training is conducted for only 30 steps.

Mathematical reasoning results are reported here. The reward and validation Pass @1 performance are visualized on AIME2024 every 10 steps during training in FIG. 6A. It can be observed that the reward steadily increases during the initial training phase and begins to converge after approximately the 150th step. Meanwhile, the validation accuracy (Pass@ 1) improves rapidly, rising from around 0.07 to 0.20 over the course of training. This demonstrates that, through budget-constrained rollout, the model can quickly learn to reason effectively when the thinking phase is incomplete.

It is reported that Pass@ 1 accuracy versus the number of tokens used across five math benchmarks AIME, AMC, Olympiad-Bench, MATH500, and Minerva Math in FIG. 6B. The proposed method, El-Math-1.5B, under both budget-constrained and 24K-token settings (red stars), consistently outperforms S1 (Budget Forcing) and Ll-Exact, and performs competitively with Ll-Max, while requiring significantly fewer training steps. On MATH500, El-Math-1.5B achieves a Pass @1 accuracy of 83.6% using only 1619 tokens per question, whereas Ll-Exact and L1-Max yield lower or comparable performance with more tokens (L1-Exact: 79.9% with 1959 tokens; L1-Max: 83.6% with 1796 tokens). Notably, when evaluated without inference-time budget constraints, El-Math-1.5B achieves higher accuracy than all baseline methods across all benchmarks. For example, on AIME2024, El-Math-1.5B exhibits a performance degradation of only 6.0% relative to the original model, compared to 12.9% for L1-Max and 16.8% for L1-Exact. These results demonstrate that the disclosed framework and method are not only effective in enforcing inference-time budget constraints but also preserves most of the original model's performance. When compared with the original DeepScaleR-1.5B, El-Math-1.5B reduces the average number of tokens used across datasets by more than 30%, including a 32.1% reduction on AIME2024.

Furthermore, similar to Ll, S1, and O1, it is observed that a clear log-linear scaling pattern in El: performance improves approximately linearly with respect to the logarithm of the number of generated reasoning tokens.

Code reasoning results are reported here. As shown in FIG. 6C, the Pass@1 accuracy is visualized on LiveCodeBench under varying generation budgets, comparing the disclosed method to a simple elastic reasoning strategy for thinking and solution. It is observed that the original DeepCoder-14B-Preview fails to generate correct outputs when reasoning is incomplete, consistently achieving less than 10% accuracy when inference budget is less than 4K even using elastic reasoning. In contrast, the E1-Code-14B model used in this disclosure demonstrates impressive scalability: its performance improves steadily as the inference budget increases, highlighting the effectiveness of the training strategy in enabling the model to reason adaptively under constrained thinking. Notably, El-Code-14B also achieves a performance improvement of 0.3% on LiveCodeBench even in the unconstrained setting, while simultaneously reducing the average number of generated tokens by 37.4%—from 17,815 to 11,145 tokens. This indicates that the method not only scales well with inference budgets but also promotes more concise and efficient reasoning.

In FIG. 6D, the performance of E1-Code-14B is reported on four benchmarks: LiveCodeBench, Codeforces, HumanEval Plus, and AIME2024. Consistent test-time scaling behavior is observed across all benchmarks under constrained inference budgets. Beyond scalability, the disclosed model also demonstrates strong performance in the unconstrained setting. Specifically, performance improvements are observed on LiveCodeBench, Codeforces, and HumanEval Plus, and only a slight performance drop on AIME2024. On Codeforces, El-Code-14B achieves a 42-point improvement in rating and a 0.6 percentile gain, outperforming 03-Mini-2025-1-31 (Low) and performing comparably to 01-2024-12-17 (Low). These results highlight that the disclosed method not only enables efficient, budget-constrained reasoning but also enhances overall reasoning capability, even in unconstrained scenarios.

Analysis and discussions are provided as follows. To better understand which components of the reasoning process are enhanced through training, ablation experiments on DeepScaleR-1.5B-Preview and El-Math-1.5B are conducted using the AIME2024 benchmark. Specifically, the thinking and solution segments/portions are separately generated using both models under varying generation budgets. For example, DeepScaleR-1.5B-Preview is used to generate the thinking part, and then El-Math-1.5B is used to generate the corresponding solution based on that reasoning. This setup allows us to isolate the contributions of each model to the reasoning pipeline and assess how training improves each component.

As shown in FIG. 6E, it is observed that both the thinking and solution are enhanced after training. Notably, the improvement in the solution component is more substantial, particularly under constrained thinking budgets. For instance, using the El model to generate only the solution segment yields an 8.7% gain in accuracy compared to using the original DeepScaleR model, under a generation budget of (0.5K+1K) tokens. This highlights the effectiveness of budget-constrained rollout in strengthening the model's ability to produce high-quality solutions based on incomplete reasoning.

This observation also helps explain why training with a fixed budget constraint (e.g., (1K, 1K)) enables the model to generalize effectively to a wide range of budget configurations. It is hypothesized that the improvement in solution generation plays a central role in this generalization, allowing the model to adapt even when the available thinking tokens are reduced.

Ablation of training budget t* is discussed as follows. To further investigate the role of the thinking budget t* in the proposed budget-constrained rollout, experiments to evaluate the model's performance are conducted under four settings: t*∈{0.5K, 1K, 2K, 3K}, while keeping the solution budget fixed at α*=1K. Five math benchmarks: AIME, AMC, Olympiad-Bench, MATH500, and Minerva Math are evaluated on (FIG. 6F).

Across all configurations, the model demonstrates strong generalization to varying inference budgets on all benchmarks. Among the tested values, t*=1K consistently achieves the best performance, while also maintaining a low maximum generation length of 2K tokens, making it a highly efficient and effective setting. Based on this trade-off between performance and computational cost, (t*=1K, s*=1K) is adopted as the default configuration.

Token allocation between thinking and solution is discussed as follows. FIG. 6G visualizes the distribution of thinking and solution tokens within generated trajectories under different generation budget constraints. AIME2024 is selected for the math task and LiveCodeBench for the coding task.

For AIME2024, as the inference budget decreases, the number of tokens used in the thinking segment decreases accordingly, while the number of tokens in the solution segment slightly increases. A similar trend is observed on LiveCodeBench, where the thinking tokens decrease with tighter budgets, while the number of solution tokens remains relatively stable.

Notably, even when evaluated without budget constraints, the trained E1 models demonstrate substantial token efficiency: they reduce total token usage by 32.1% on AIME2024 and 37.4% on LiveCodeBench, while maintaining strong performance (even slightly better than the baseline model). This suggests that the model has learned to reason more concisely and generate efficient solutions post training.

Iterative training is discussed. In this section, Whether the model can benefit from iterative training is investigated—that is, performing a second round of training with expanded budgets after initial training. Specifically, the model is first trained using a budget of (t*=1K, a*=1K), and then continue to be trained from the resulting checkpoint using a larger thinking budget of (t*=3K, a*=1K). The results on AIME2024 are reported in FIG. 6H.

Surprisingly, the second round of training does not improve performance. In fact, it is observed that a slight degradation in accuracy, suggesting that once the model has learned to reason effectively under a shorter budget, further training with a longer budget may not provide additional benefits.

In this disclosure, a unified RL framework (e.g., 250) for enabling large reasoning models to generate accurate and efficient chain-of-thought outputs under strict inference-time constraints. By explicitly separating the reasoning process into thinking and solution phases, and training with a novel budget-constrained rollout strategy, the disclosed approach ensures robustness to truncated reasoning while preserving or even improving overall performance. Elastic reasoning significantly reduces token usage during inference, generalizes across unseen budget configurations, and outperforms prior length control baselines in both mathematical and programming domains. The findings offer a scalable and principled solution for real-world deployment of reasoning LLMs where computation budgets are limited. It is believed this framework opens new directions for budget-aware reasoning.

This description and the accompanying drawings that illustrate inventive aspects, embodiments, implementations, or applications should not be taken as limiting. Various mechanical, compositional, structural, electrical, and operational changes may be made without departing from the spirit and scope of this description and the claims. In some instances, well-known circuits, structures, or techniques have not been shown or described in detail in order not to obscure the embodiments of this disclosure. Like numbers in two or more figures represent the same or similar elements.

In this description, specific details are set forth describing some embodiments consistent with the present disclosure. Numerous specific details are set forth in order to provide a thorough understanding of the embodiments. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

Although illustrative embodiments have been shown and described, a wide range of modification, change and substitution is contemplated in the foregoing disclosure and in some instances, some features of the embodiments may be employed without a corresponding use of other features. One of ordinary skill in the art would recognize many variations, alternatives, and modifications. Thus, the scope of the invention should be limited only by the following claims, and it is appropriate that the claims be construed broadly and, in a manner, consistent with the scope of the embodiments disclosed herein.

What is claimed is:

1. A method for building an artificial intelligence (AI) agent, comprising:
obtaining a training dataset including a training query and a groundtruth answer;
generating, by a first neural network based language model, a training output including a reasoning portion subject to a first generative budget and a solution portion that results from the reasoning portion subject to a second generative budget, in response to the training query;
assigning a reward, by a second neural network based language model, based on a comparison between the solution portion and the groundtruth answer;
updating parameters of the first neural network based language model based on a gradient of an expected return based on the reward over a period of time;
iteratively refining, by the updated first neural network based language model, the training output while maintaining the training output under a total generative budget;
generating, by the trained first neural network based language model, a reasoning that arrives at a final solution to a user query, wherein the reasoning is subject to a user defined generative budget; and
building, at a server the AI agent employing a trained first neural network based language model.

2. The method of claim 1, wherein the first generative budget or the second generative budget includes at least one of a maximum number of tokens, a maximum number of processor cycles, a maximum memory usage, a maximum time of generation, or a combination thereof.

3. The method of claim 1, further comprising:
allocating the first generative budget and the second generative budget from a total generative budget based on a tunable ratio.

4. The method of claim 1, wherein the training dataset includes:
a math reasoning query and a math answer, or
a code reasoning query and a code snippet.

5. The method of claim 1, wherein the generating of the training output includes forcibly inserting a special token at an end of the first generative budget to discontinue the reasoning portion in response to the reasoning portion being incomplete at the end of the first generative budget.

6. The method of claim 1, wherein the generating of the training output, the assigning the reward, and the updating of the parameters of the first neural network language model are based on a group relative policy optimization (GRPO).

7. The method of claim 1, further comprising:
receiving an input query and a generative budget that is different from the first generative budget or the second generative budget; and
generating, by the trained neural network based model, an output comprising a reasoning and a solution subject to the generative budget.

8. The method of claim 1, wherein the first generative budget is equal to the second generative budget in a training of the first neural network based language model.

9. A system for building an artificial intelligence (AI) agent, the system comprising:
a memory that stores a first neural network based language model, a second neural network based language model, and a plurality of processor executable instructions;
a communication interface that receives a training dataset including a training query and a groundtruth answer; and
one or more hardware processors that read and execute the plurality of processor-executable instructions from the memory, wherein the plurality of processor-executable instructions are configurable to cause the system to perform operations comprising:
generating, by the first neural network based language model, a training output including a reasoning portion subject to a first generative budget and a solution portion that results from the reasoning portion subject to a second generative budget, in response to the training query;
assigning a reward, by the second neural network based language model, based on a comparison between the solution portion and the groundtruth answer;
updating parameters of the first neural network based language model based on a gradient of an expected return based on the reward over a period of time;
iteratively refining, by the updated first neural network based language model, the training output while maintaining the training output under a total generative budget;
generating, by the trained first neural network based language model, a reasoning that arrives at a final solution to a user query, wherein the reasoning is subject to a user defined generative budget; and
building, at a server the AI agent employing a trained first neural network based language model.

10. The system of claim 9, wherein the first generative budget or the second generative budget includes at least one of a maximum number of tokens, a maximum number of processor cycles, a maximum memory usage, a maximum time of generation, or a combination thereof.

11. The system of claim 9, wherein the operations further include:
allocating the first generative budget and the second generative budget from a total generative budget based on a tunable ratio.

12. The system of claim 9, wherein the training dataset includes:
a math reasoning query and a math answer, or
a code reasoning query and a code snippet.

13. The system of claim 9, wherein the generating of the training output includes forcibly inserting a special token at an end of the first generative budget to discontinue the reasoning portion in response to the reasoning portion being incomplete at the end of the first generative budget.

14. The system of claim 9, wherein the generating of the training output, the assigning the reward, and the updating of the parameters of the first neural network language model are based on a group relative policy optimization (GRPO).

15. The system of claim 9, wherein the operations further include:
receiving an input query and a generative budget that is different from the first generative budget or the second generative budget;
generating, by the trained neural network based model, an output comprising a reasoning and a solution subject to the generative budget.

16. The system of claim 9, wherein the first generative budget is equal to the second generative budget in a training of the first neural network based language model.

17. A non-transitory machine-readable medium comprising a plurality of instructions, executable by one or more processors, wherein the plurality of instructions are configurable to cause the one or more processors to perform operations comprising:
obtaining a training dataset including a training query and a groundtruth answer;
generating, by a first neural network based language model, a training output including a reasoning portion subject to a first generative budget and a solution portion that results from the reasoning portion subject to a second generative budget, in response to the training query;
assigning a reward, by a second neural network based language model, based on a comparison between the solution portion and the groundtruth answer;
updating parameters of the first neural network based language model based on a gradient of an expected return based on the reward over a period of time;
iteratively refining, by the updated first neural network based language model, the training output while maintaining the training output under a total generative budget;
generating, by the trained first neural network based language model, a reasoning that arrives at a final solution to a user query, wherein the reasoning is subject to a user defined generative budget; and
building, at a server the AI agent employing a trained first neural network based language model.

18. The non-transitory machine-readable medium of claim 17, wherein the first generative budget or the second generative budget includes at least one of a maximum number of tokens, a maximum number of processor cycles, a maximum memory usage, a maximum time of generation, or a combination thereof.

19. The non-transitory machine-readable medium of claim 17, wherein the operations further include:
allocating the first generative budget and the second generative budget from a total generative budget based on a tunable ratio.

20. The non-transitory machine-readable medium of claim 1, wherein the training dataset includes:
a math reasoning query and a math answer, or
a code reasoning query and a code snippet.
